(19) United States
(12) Patent Application Publication
(10) Pub. No.: US 2025/0182645 A1
(43) Pub. Date: Jun. 5, 2025

(54) PROPRIOCEPTION SYSTEM FOR A DRIVING SIMULATOR

(71) Applicant: GENINVEST, Sevres (FR)

(72) Inventor: Philippe LOUBENS, Sevres (FR)

(21) Appl. No.: 18/730,230

(22) PCT Filed: Oct. 5, 2022
(86) PCT No.: PCT/IB2022/059495

§ 371 Date: Jul. 18, 2024

(30) Foreign Application Priority Data
Oct. 5, 2021 (FR) FR2110491

(51) Int. Cl. G09B 9/052; G09B 9/05

(52) U.S. Cl. CPC G09B 9/052; G09B 9/05

(57) ABSTRACT

A proprioception system comprising a first structure bearing a seat or cabin which is oriented in a front-to-rear direction, a pivot link pivoting about a horizontal axis between the first structure and a second structure, the second structure being deformable following the geometry of an isosceles trapezoid which is deformable between the pivot link and a base of the second structure, and a guide means for moving the base along a front-to-rear linear path over a support. A first actuator controls the pivoting of the first structure relative to the second structure, a second actuator controls the deformation of the second structure, and a third actuator controls the translation of the second structure relative to the support. Finally, it comprises means for coordinated control of the first, second and third actuators. The invention is applicable to vehicle driving or piloting simulators.

### FIELD OF THE INVENTION

The present invention concerns a proprioceptive, immersive, adaptive and connected driving or piloting system, designed to generate proprioceptive effects particularly during acceleration, braking and cornering when driving a vehicle.

### PRIOR ART

For example, WO2018185658A1 describes a proprioception system comprising mechanical guide hoops for moving a seat for a user along curved trajectories.

In such a system, it is also possible to eliminate the mechanical seat support hoops that existed in the prior art and in particular in the document, since accelerations are created here by electronically controlling independent movements.

### SUMMARY OF THE INVENTION

More particularly, it concerns a new dynamic system capable of supporting any type of seat or cabin for one or more drivers or pilots, and providing particularly effective, reliable and compact gravitational accelerations using particular combinations of movements.

According to a first aspect, a proprioception system is proposed for this purpose, comprising a first structure bearing a seat or cabin oriented in a front-to-rear direction, a pivot link pivoting a horizontal axis between the first structure and a second structure, the second structure being deformable according to the geometry of a deformable isosceles trapezoid between said pivot link and a base of the second structure, and a guide means for moving the base in a front-to-rear linear path on a support, a first actuator for controlling the pivoting of the first structure relative to the second structure, a second actuator for controlling the deformation of the second structure, and a third actuator for controlling the translation of the second structure relative to the support, and means for coordinated control of the first, second and third actuators.

The system optionally comprises the following additional features, taken individually or in any combination that a person skilled in the art will understand as being technically compatible with one another:
the isosceles trapezoid determining the deformation geometry of the second structure has an apex whose length is between 60 and 85% of the length of the base, and side arms whose length is between 55 and 75% of the length of the base.
the first actuator comprises a cylinder operating between points on the first structure and the second structure remote from said pivot link.
the second actuator comprises a cylinder operating between opposite regions of the deformable isosceles trapezoid.
the pivot link between the first and second structures is located at a position lower than a region of the seat or cabin where the user's head is intended to be located, and the coordinated control means are adapted to control the first actuator and the third actuator in such a way that horizontal movement of said region is minimized.
the system further comprises a device for displaying a virtual environment for a user seated in the seat or cabin.
the display device comprises at least one screen attached to a movable support, and a device for controlling the movement of the display device as a function of the movement of the seat or cabin.
the system further comprises a screen for concealing the real environment around the system and the display device.

A simulation system, in particular a driving simulation system, is also proposed, comprising a proprioception system as defined above, sensor means for detecting driving actions by a user seated in the system, a display device for the user, and a control device responsive to signals supplied by the sensor means for coordinated control of a dynamic scene represented by the display device and the movements of the system by means of its actuators.

### BRIEF DESCRIPTION OF THE DRAWINGS

Other aspects, aims and advantages of the present invention will become more apparent on reading the following detailed description of preferred embodiments thereof, given by way of non-limiting example and with reference to the attached drawings.

In the drawings:

FIGS. 1A and 1B are respectively a side view and a front view of a proprioception system according to the invention, in a neutral position,

FIGS. 2A-2B to 6A-6B are side and front views respectively of the system in FIGS. 1A and 1B, in positions displaced from the neutral position,

FIGS. 7A to 7H illustrate different postures of the system for different commands on two system actuators, and

FIG. 8 shows a superimposition of different postures of the system to demonstrate a certain geometric property.

### DETAILED DESCRIPTION OF PREFERRED EMBODIMENTS

As a preliminary matter, it should be noted that from one figure to the next, identical or similar elements or parts are designated whenever possible by the same reference signs, and will not be described each time.

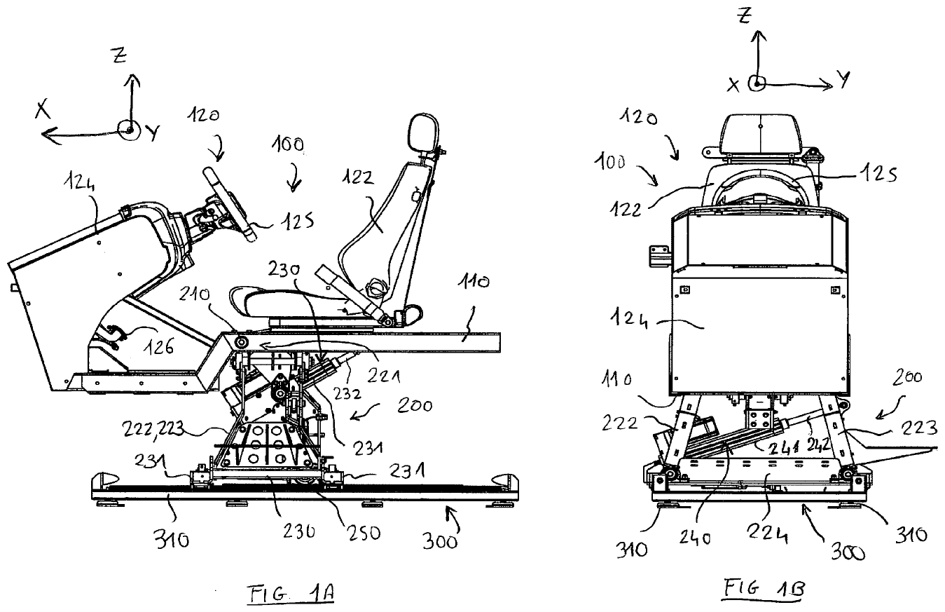

Referring first to FIGS. 1A and 1B, a proprioceptive, immersive, adaptive and connected system is shown in an initial state or neutral position. Longitudinal X, transverse Y and vertical Z directions are shown in these figures.

The system comprises an upper part 100 comprising a platform 110 bearing a driver station 120 comprising a seat 122 and control elements, in this case a block 124 comprising a steering wheel 125 and pedals 126. These elements are connected to appropriate sensors in a manner known per se.

The upper part 100 is carried by a movable intermediate structure 200 which, in cross-section, forms a deformable isosceles trapezoid 220, this structure comprising a connection 210 pivoting about an axis parallel to Y between an upper region 221 of the trapezoid and the platform 110, while a cylinder 230 comprising a cylinder body 231 and a cylinder rod 232 operates between said upper region 221 and the platform 110, being connected thereto along pivotal connections of axes parallel to the transverse axis Y, to control the pivoting of said platform 110 and hence of the driver station 120 as will be seen in detail below.

The two side legs of the trapezoid 220 are designated by references 222 and 223 in FIG. 1B. Its base is designated by reference 224. Note that the stability of the intermediate structure with respect to rotation about the transverse horizontal axis is preferably achieved by providing two deformable trapezoids, front and rear respectively, designated by references 220av and 220ar. The deformability of the trapezoids is achieved by pivotal connections about respective axes oriented along the horizontal longitudinal axis X (the axis perpendicular to the drawing in FIG. 1B).

The base 224 of the deformable trapezoid(s) is defined by a platform 230 of the intermediate structure, this platform bearing wheels 231 by which it can move with guidance on horizontal rails 310 carried by a fixed ground structure 300, the rails 310 being oriented in the front-to-rear or longitudinal direction X.

The deformation of the trapezoid(s) is achieved here by a cylinder 240 comprising a cylinder body 241 and a cylinder rod 242, which operates between the region of a lower corner of the deformable trapezoid 220 and the region of the opposite upper corner, being attached to the trapezoid in these regions with the possibility of pivoting along an axis oriented in the X direction.

The front and rear movement of the structures 100 and 200 on the rails is ensured by a motor 250 or a cylinder.

The system receives input signals from the pedals and steering wheel (acceleration, braking and direction changes), to control the running of a virtual reality representation either in a virtual reality headset or on one or more display screens immersively surrounding the user, and to control the movements of the driving station 120 by controlling the cylinders 230, 240 and the motor 250 to apply the corresponding accelerations and orientations to the user's body.

Cylinders 230, 240 and motor 250 are preferably electric.

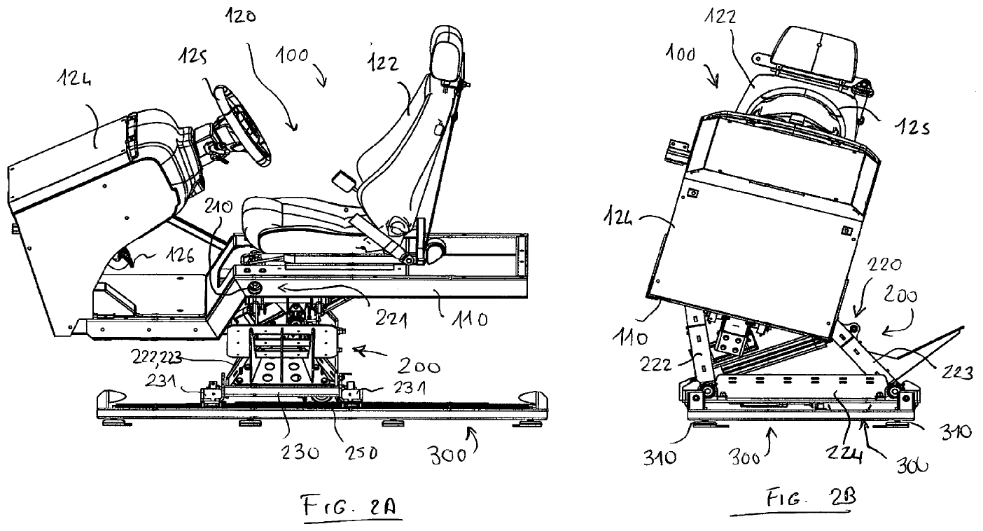

FIGS. 2A, 2B to 6A, 6B show the system with different positions of the driver station 120.

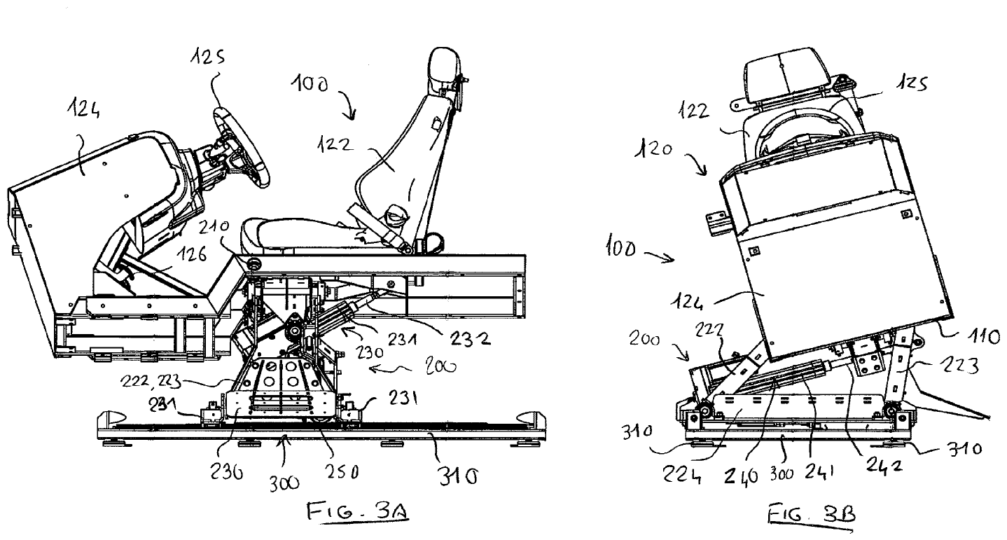

In FIGS. 2A and 3B, the cylinder 240 has been activated to tilt the driving position to the left (relative to the driving direction), generating a lateral force to the left for the user; this typically corresponds to the force experienced when turning to the right; this effect is typically adjustable according to the curvature of the turn and the speed at which it is taken.

In FIGS. 3A and 3B, the driver station is tilted to the opposite side.

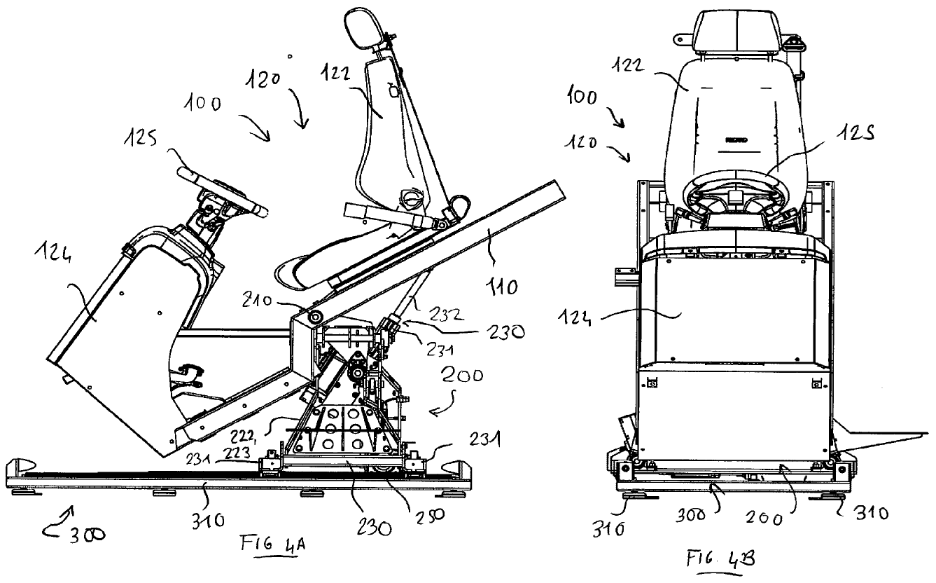

In FIGS. 4A and 4B, the cylinder 230 tilts the driver station 120 so that the driver leans forward, applying a braking force to the driver. The inclination varies according to the braking force, and this effect can be combined with a movement of the system on the rails 310 using the motor 250, particularly if a frontal impact effect is desired.

FIGS. 5A and 5B illustrate the tilting of the driver station 120 in the opposite direction, corresponding to a vehicle acceleration situation, the tilting being controlled to be greater when stronger acceleration is simulated. Similarly, a movement along the rails 310 can be applied by the motor 250 to simulate a rear impact.

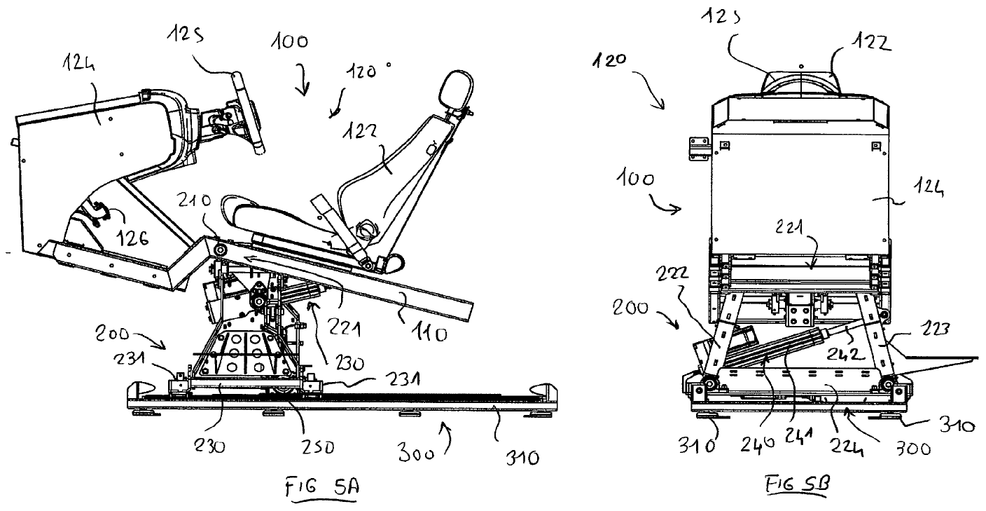

FIGS. 6A and 6B illustrate the case of braking in a bend, with the driver station 120 leaning both forward and to the right, thanks to a combination of the actions of cylinders 230 and 240.

By carefully combining the controls for cylinders 230, 240 and motor (or cylinder) 250, it is possible to achieve a large number of proprioceptive effects, while minimizing the harmful effects associated in particular with the movement of the user's head.

In this respect, the use of an isosceles trapezoid deformation prevents the user's head from crossing the seat's axis of rotation when the movement is initiated, so that it resists the centrifugal force produced by this tilting. The design of these trapezoids is based on relatively precise choices of the respective lengths of the base, top and side arms. In one particular example, these dimensions are 60 cm for the base, 50 cm for the top and 35 cm for the side arms. More generally, the length of the top is between 60 and 85% of the length of the base, and the length of the side arms is between 55 and 75% of the length of the base.

It should also be noted that the rotation of the driver station 120 relative to the structure 200 about the axis extending in the Y direction (link 210) can take place at the base of the seat 122, as shown, or at any other suitable location, it being noted that the combination of pivoting forwards or backwards and translation along the rails 310 can be optimized according to the signals delivered by the position sensors fitted to the virtual reality headset at the time the pilot dons it.

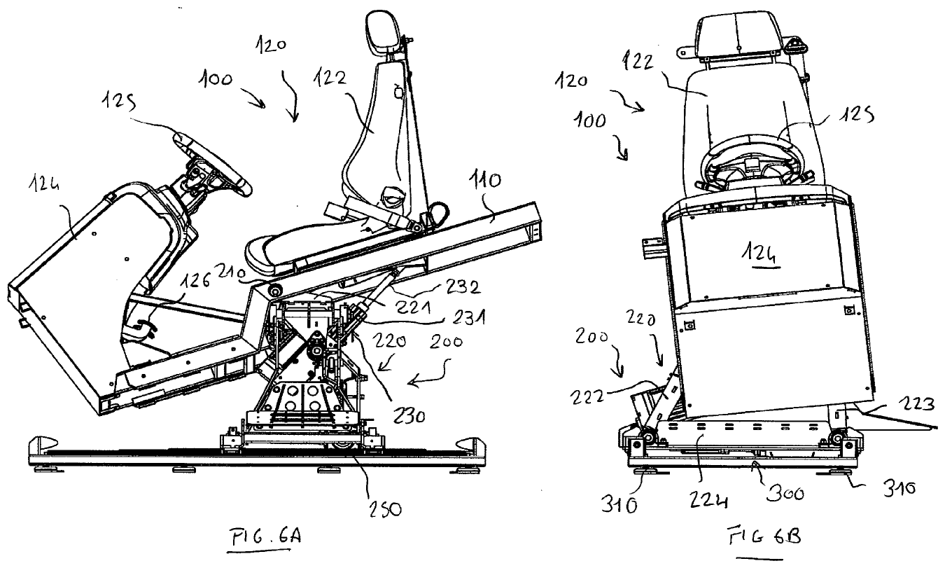

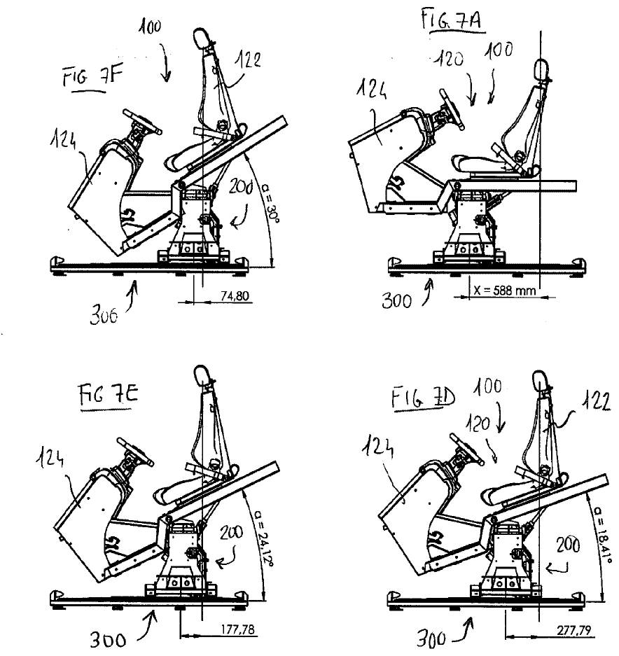

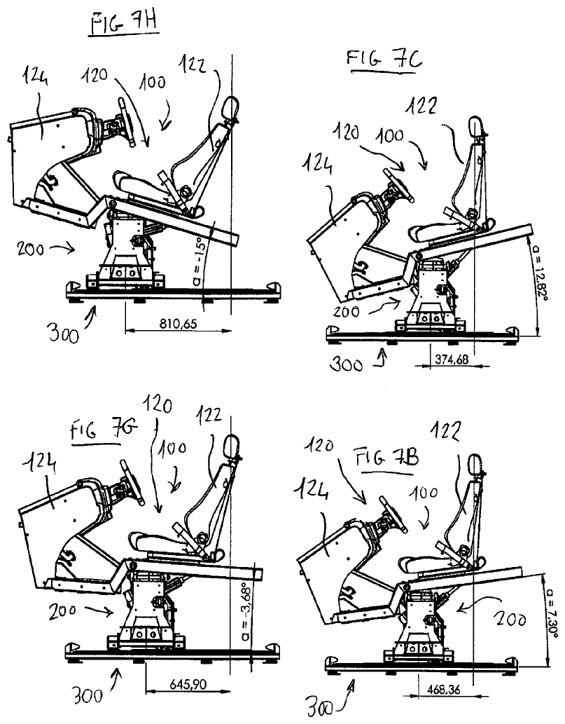

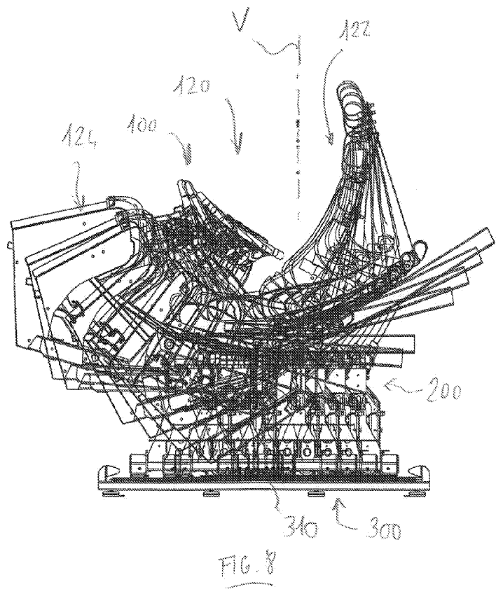

Compared with moving the driver station on hoops, as shown in document WO2018185658A1, the kinematics obtained by deforming a deformable isosceles trapezoid in a transverse plane YZ provides several advantages:
for the same lateral movement, it significantly increases the angle of inclination, enabling a greater amount of acceleration to be felt for a given lateral movement,
it makes it easier to hold and guide the driver station, which is more complex to design and build, and more difficult to stabilize, when it has to run on hoops,
finally, it avoids the need to raise the driver station along the hoops when tilting around an axis parallel to the Y-direction (typically in the event of violent acceleration/braking), which would require much more powerful motors to overcome the force of gravity, and recourse to balancing systems for moving masses that would be heavy, complex and not always reliable,
on the contrary, in the present invention, the seat, while moving concomitantly, only pivots about its axis in the Y direction with balanced masses on either side, which limits the power requirement of the two cylinders;
it nevertheless minimizes the driver's head movements, based on two movement control actions:
when the driver is seated, the position of the head (actually the inner ear) is detected using sensors, for example the external sensors fitted to a virtual reality headset (sensors fitted in particular to a commercial headset manufactured by HTC, Taipei, known as the “Vive Pro”), or any appropriate sensor in the case of images projected onto screens, this position being used as a reference position for controlling seat movements
then, the system systematically and automatically compensates for the longitudinal movement of the head caused by seat rotation by performing an opposite movement of the same magnitude using motor 250 along rails 310, so that essentially it does not move forward or backward (in fact, it merely moves up or down with the body along a straight line or a slight arc of a circle, as shown in FIGS. 7A to 7H).

It is these kinematics, with the body tilted, that provide gravitational deceleration, up to the very highest levels, without the major side effect of pelvic or lumbar recoil experienced with a tilting movement that is not corrected in this way.

FIGS. 7A to 7H show, for different settings of the cylinder 230 and motor (or cylinder) 250, the distance taken horizontally between the head and pivot link 210, and how the upper body moves tangentially to a vertical arc of a circle. The seat's set-back distance from its axis of rotation 210, preferably in the order of 550 to 600 mm depending on the user's size and position, makes it possible to provide, without any parasitic effect, by simple rotation at the level of the pivoting link 210 between the structures 100 and 200, an upward or downward acceleration, creating a very realistic lifting and lowering effect of the seat in the event of the vehicle taking off due to a speed bump or crossing a speed bump, median strip or kerb.

Conversely, to create a longer or stronger acceleration effect, it is also possible not to compensate for all longitudinal movements of the head, as long as the head moves forward when the movement is initiated.

FIGS. 7A (neutral position) and 7B to 7F show that when the structure 100 is tilted forward at different angles, while the structures 100 and 200 are moved back together by corresponding specified distances, the user's head (in this case, the seat headrest 122) does not experience any horizontal movement component, while different braking intensities are simulated (different tilting angles of the structure 100). FIG. 8, which shows a superimposition of numerous views of the system in different positions, clearly shows that the user's head, previously located by the virtual reality headset sensor(s) or others as aforementioned, and whose position is taken into account to drive the movements of the cylinder 230 and motor (or cylinder) 250, moves along a generally vertical rectilinear trajectory V during the position changes exerted to simulate acceleration or braking.

Conversely, FIGS. 7G and 7H show the same effect for two rearward tilts of the structure 100, simulating two levels of acceleration without the user's head undergoing any substantial horizontal movement.

As mentioned above, the system described above can be supplemented by the addition of N panoramic display screens (typically three screens) arranged side-by-side with suitable tilts, replacing the virtual reality headset.

Rather than incorporating these screens into the pedal and steering wheel support structure, which would unbalance it, make it heavier, and create a space-consuming lateral clutter of the simulator, while requiring the industrial development of a specific model, according to another aspect (not shown), the system incorporates a telescopic arm with movements controlled in synchronization with those of the driver station and supporting the screens, this arm being mounted on a fixed support, for example on the ceiling of a room in which the system is installed.

The structure supporting the screens advantageously incorporates a screen pivoting at both ends on its horizontal axis, so as to conceal the visual space corresponding to the terrestrial reference frame for the various possible seat positions, and avoid the effects of driver nausea.

When stationary, the arm can be deployed in the “lecturer” position to project the students' driving patterns in turn during the feedback and discussion sessions with the instructor, with the screen in the anti-reflective position, acting as a resonance chamber above the screens.

Of course, the present invention is by no means limited to the embodiments described above and shown; rather, the person skilled in the art will know how to make numerous variants or modifications.

It applies to the simulation of driving vehicles, in particular wheeled land vehicles, more specifically motor vehicles.

1. A proprioception system comprising a first structure bearing a seat or cabin oriented in a front-to-rear direction, a pivot link pivoting a horizontal axis between the first structure and a second structure, the second structure being deformable according to the geometry of a deformable isosceles trapezoid between said pivot link and a base of the second structure, and a guide for moving the base in a front-to-rear linear path on a support, a first actuator for controlling the pivoting of the first structure relative to the second structure, a second actuator for controlling the deformation of the second structure, and a third actuator for controlling the translation of the second structure relative to the support, and a control unit for coordinated control of the first, second and third actuators.

2. The system according to claim 1, wherein the isosceles trapezoid determining the deformation geometry of the second structure has an apex whose length is between 60 and 85% of the length of the base, and side arms whose length is between 55 and 75% of the length of the base.

3. The system according to claim 1, wherein the first actuator comprises a cylinder operating between points on the first structure and the second structure remote from said pivot link.

3. The system according to claim 1, in which the second actuator comprises a cylinder operating between opposite regions of the deformable isosceles trapezoid.

4. The system according to claim 1, wherein the pivot link between the first and second structures is located at a position lower than a region of the seat or cabin where the user's head is intended to be located, and the control unit is configured to control the first actuator and the third actuator in such a way that horizontal movement of said region is minimized.

5. The proprioception system according to claim 1, further comprising a device for displaying a virtual environment for a user seated in the seat or cabin.

6. The system according to claim 5, wherein the display device comprises at least one screen attached to a movable support, and a device for controlling the movement of the display device as a function of the movement of the seat or cabin.

7. The proprioceptive system according to claim 6, further comprising a screen for concealing the real environment around the system and the display device.

8. A simulation system, in particular a driving simulation system, comprising a proprioception system according to claim 1, at least one sensor for detecting driving actions by a user seated in the proprioception system, a display device for the user, and a control device responsive to signals supplied by said at least one sensor for coordinated control of a dynamic scene represented by the display device and of the movements of the system by the actuators.
